(19) United States
(12) Patent Application Publication
(10) Pub. No.: US 2010/0214776 A1
(43) Pub. Date: Aug. 26, 2010

(54) LIGHTING DEVICE, IN PARTICULAR LIGHT SIGNALLING SUPPLEMENTARY DEVICE FOR RESCUE AND EMERGENCY PRIORITARY VEHICLES

(75) Inventors: Luciano Franceschelli, Ariccia - Rome (IT); Maurizio Francescangeli, Ariccia - Rome (IT); Angelo Mancini, Ariccia - Rome (IT)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INTAV S.R.L., Ariccia - Rome (IT)

(21) Appl. No.: 12/670,096

(22) PCT Filed: Jan. 4, 2008
(86) PCT No.: PCT/IT2008/000011

§ 371 Date: May 5, 2010

(30) Foreign Application Priority Data
Jul. 25, 2007 (IT) RM2007A000408
Oct. 8, 2007 (IT) RM2007A000531

(51) Int. Cl. F21V 9/00; F21V 1/00

(52) U.S. Cl. 362/231; 362/235; 362/294

(57) ABSTRACT

The invention concerns a lighting device (100,100′), wherein the light source comprises a plurality of LEDs (110) and a reflecting body (120) for the housing of the source and the conveying of the light according to a pre-defined exit angle of the light beam, characterised in that: the internal surface (125) of said reflecting body (120) has a cross-section, with respect to its principal extension direction, that comprises at least two portions (121, 121′) of a parabola which are symmetrical with respect to the axis of the same parabola; substantially in the focus of said cross-section is housed a plurality of LED (110); the LEDs (110) of said plurality of LEDs being connected to a first side of a laminar strip (130), on the second side (132) of the laminar strip, side facing in the direction opposite to said reflecting body, being connected a dissipative band (140) for dissipating heat generated by the LED (110).

The invention concerns a lighting device, in particular light signaling supplementary device for rescue and emergency prioritary vehicles.

More in detail, the lighting device according to the invention is a device of supplementary light signaling to be used, for example, on vehicles that are on emergency and rescue service and more in particular a light signaling device that incorporates light emitting LED that are flashing inside a unique cavity with vertical parabolic cross-section which is suited to convey the light beams in a pre-defined circular sector, without continuity loss and increasing intensity.

Supplementary light signaling devices are known in the prior art, wherein the LED light emitters are typically single emitters with their own parabolic reflector and are mounted one nearby the other to cover the interest sector, e.g. circular sector.

Such type of structure entails project difficulties and high economical costs owing to the management and assembling of many separated elements.

Moreover, in general, these light signaling devices are subjected to specific homologation that comprises, among others conditions, a light diffusion that is pre-determined and uniformly distributed between predefined angles, so that it is needed to use, in their construction, all those expedients which are necessary and sufficient to satisfy the homologation conditions and to respect along time the production conformity requirements.

For all this, an innovative structure, simplified and reliable of such device types would allow to easily respond to the homologation requirements prescribed by the law, to cut production costs and to make the device more effective.

It is object of the present invention a lighting device that solves the prior art technique and would constitute a convenient and effective alternative thereof.

It is subject-matter of the present invention a device, wherein the light source comprises a plurality of LEDs and a reflecting body for the housing of the source and the conveying of the light according to a pre-defined exit angle of the light beam, characterised in that:
the internal surface of said reflecting body has a cross-section, with respect to its principal extension direction, that comprises at least two portions of a parabola which are symmetrical with respect to the axis of the same parabola;
substantially in the focus of said cross-section is housed a plurality of LED;
the LEDs of said plurality of LEDs being connected to a first side of a laminar strip, on the second side of the laminar strip, side facing in the direction opposite to said reflecting body, being connected a dissipative band for dissipating heat generated by the LED.
   Preferably according to the invention, said reflecting body is a solid body, optically transparent in the directions of conveying of the light beam.
   Preferably according to the invention, said reflecting body is in polycarbonate.
   Preferably according to the invention, said solid body is treated on its parabolic cross-section surface so as to impede or minimise the exit of light rays from that surface.
   Preferably according to the invention, the internal parabolic cross-section surface is polished.
   Preferably according to the invention, the internal parabolic cross-section surface is rendered wholly reflecting towards the inside of the parabola.
   Preferably according to the invention, said reflecting body is a hollow body.
   Preferably according to the invention:
the reflecting body comprises two partially reflecting elements with a principal extension direction, substantially identical and connectable with opposite corresponding profiles,
each partially reflecting element comprises a groove along said direction of principal extension, which is suited to receive said laminar strip,
the reflecting portion of each partially reflecting element presents a cross section, with respect to said principal extension direction, which is semi-parabolic, so as to form the reflecting portion of the cross-sectional reflecting body, the LEDs being placed substantially in the focus of said parabolic cross-section.
   Preferably according to the invention, said reflecting body is rectilinear, i.e. the principal extension direction is a straight line.
   Preferably according to the invention, the principal extension direction of said reflecting body is curvilinear, i.e. the principal extension direction is a curve, possibly with rectilinear stretches.
   Preferably according to the invention, the principal extension direction of said reflecting body is partially circular.
   Preferably according to the invention, said reflecting body is circular.
   Preferably according to the invention, said laminar strip is flexible.
   Preferably according to the invention, said dissipative band is in aluminium.
   Preferably according to the invention, the LEDs of said plurality of LEDs are connected so as to be equally spaced on the laminar strip.
   Preferably according to the invention, when the reflecting body is not closed, i.e. there are two end surfaces at the ends of the principal extension direction, the LEDs are connected so as to be unequally spaced in the proximity of said end surfaces, so as to have a higher concentration of LEDs close to said end surfaces.
   Preferably according to the invention, said strip is a printed circuit.
   Preferably according to the invention, said laminar strip shows, for each LED, two metallic pads for welding the LED.
   Preferably according to the invention, said laminar strip is a bimetallic printed circuit and presents for each LED a metallic pad with metallised holes for connection to a corresponding pad on the opposite side, that is directly contacting said heat dissipation band.
   Preferably according to the invention, the LEDs are lambertian LEDs.

Preferably according to the invention, before each LED, at a pre-determined distance from it, a lens is placed, in such a way that the light rays pass only or across through said lens or go impinge on the parabolic surface of said reflecting body, so as to convey all rays that come from the LED, without loss.

Preferably according to the invention, said dissipative band is integrally formed with said reflecting body.
Preferably according to the invention, said reflecting body, in the connection with said dissipative band as extension of the two parabola branch, is shaped so as to be suited to receive two respective removable contrast elements fixing said laminar strip.

Preferably according to the invention, said removable contrast elements are rubber cylindrical packing.

Preferably according to the invention, the ends of said two parabola portions opposed to the LEDs are shaped so as to constitute guide and partial seat of a transparent element for LED protection.

Preferably according to the invention, the invention device comprises a supplementary dissipative device in the case where the LEDs are red or yellow.

The invention will be now described, by way of illustration but not by way of limitation according to its preferred embodiments, making reference to the figures of the annexed drawings, wherein:

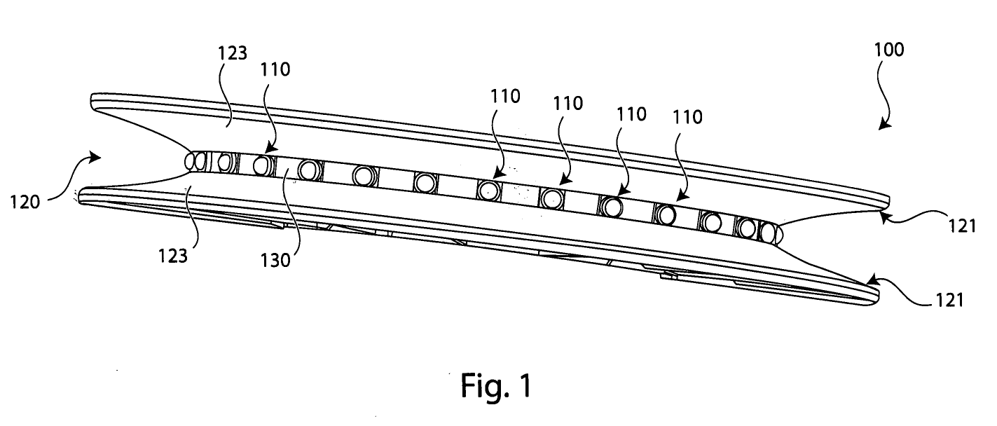

FIG. 1 shows an embodiment of the lighting device according to the present invention;

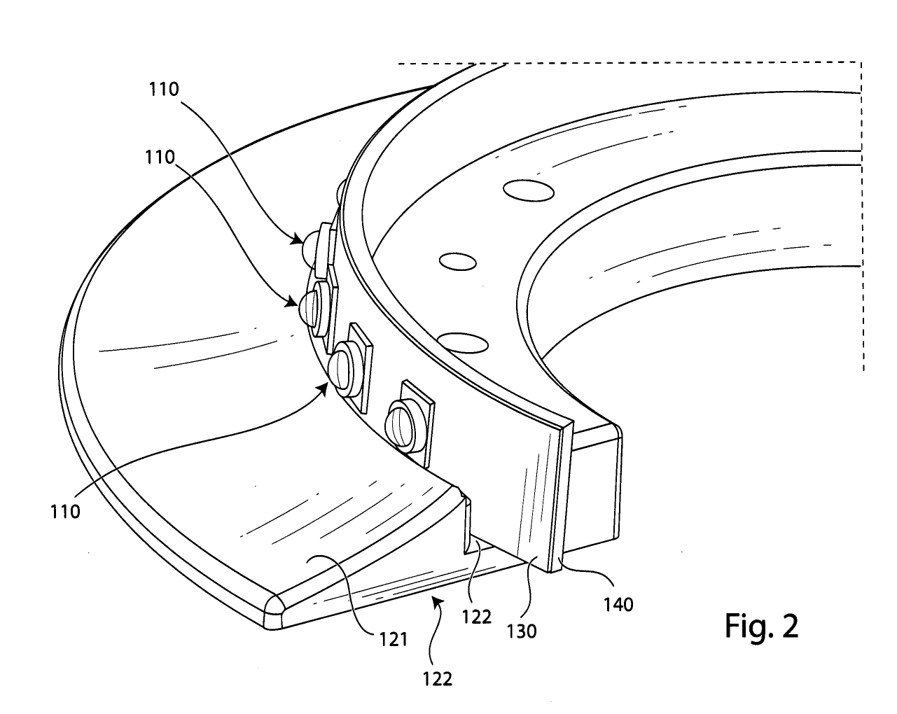

FIG. 2 shows a detail of a portion of the device according to FIG. 1;

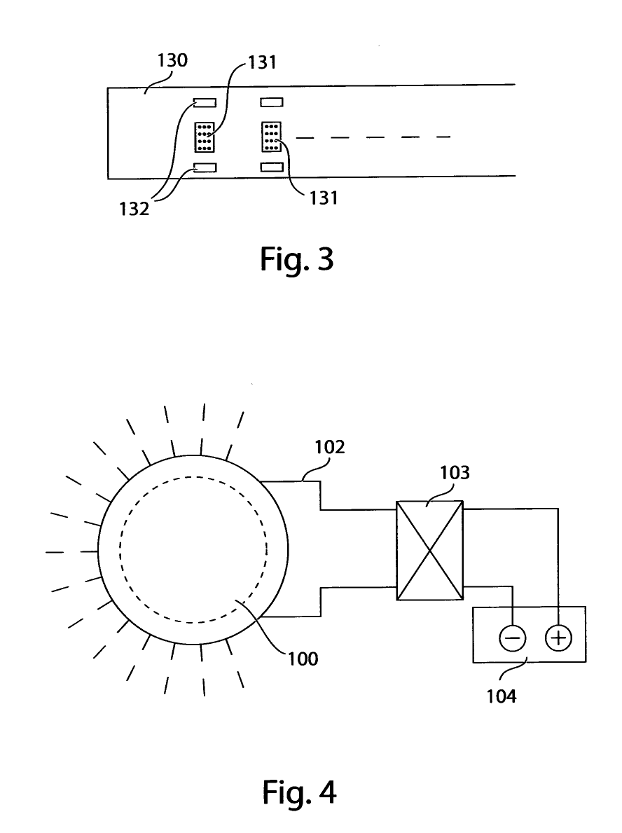

FIG. 3 shows a further detail of a portion of the device according to FIG. 2;

FIG. 4 shows an electrical connection diagram of the lighting device according to the present invention;

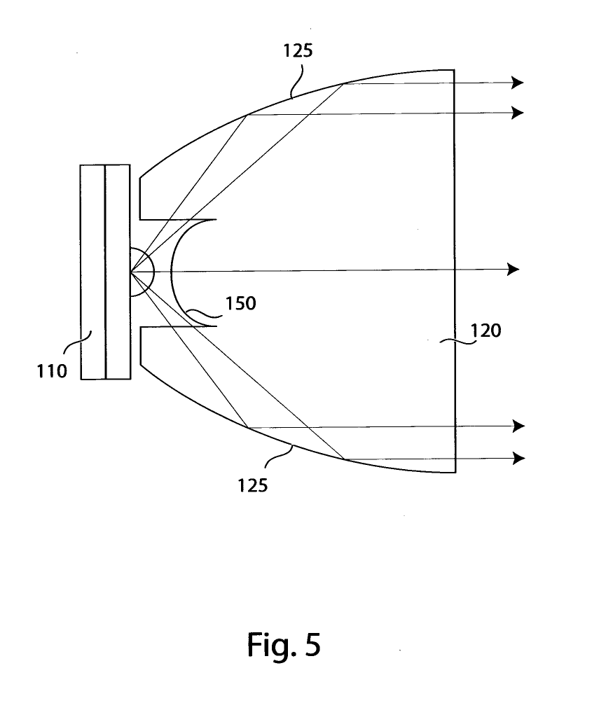

FIG. 5 shows in a schematic way a different embodiment of the device according to the present invention;

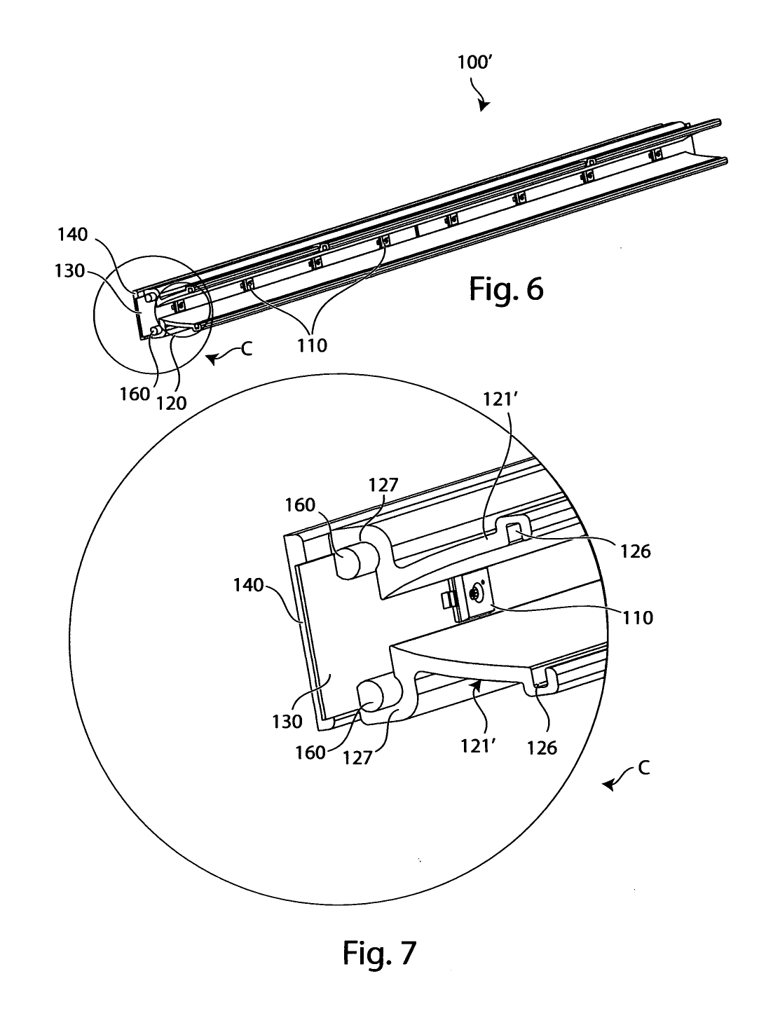

FIG. 6 shows a further different embodiment of the device according to the present invention;

FIG. 7 shows a detail of the device of FIG. 6;

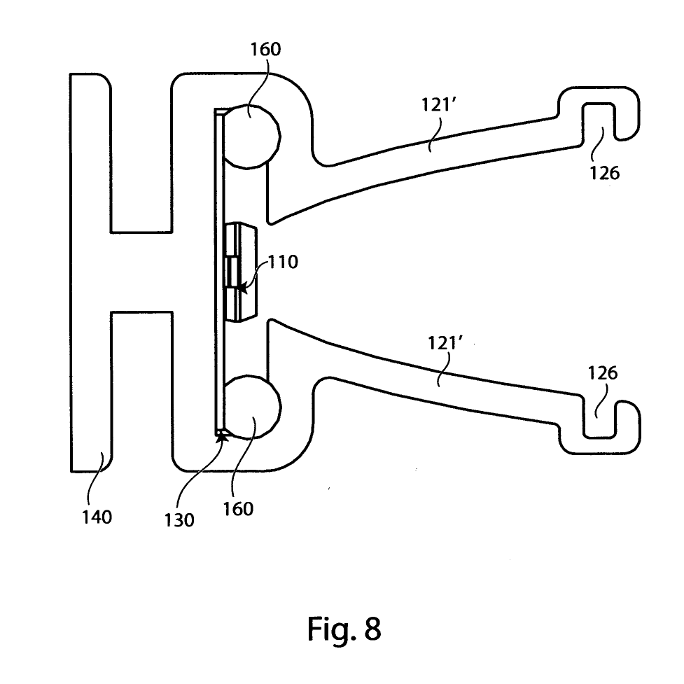

FIG. 8 shows a possible cross-section of the device of the embodiment corresponding to FIGS. 6 and 7.

In the figures, equal references will be used to indicate equal elements.

For the sake of description easiness, in the following an only embodiment of the device according to the invention will be described, however it is to be understood that many other embodiments are possible using the same inventive concept. In particular, it is to be stressed that the essential features of the invention can be implemented both in a device with circular form and in a device with rectilinear or mixed form, keeping in any case all the technical advantages illustrated in the following.

With reference to FIG. 1, in a particular example embodiment the lighting device 100 according to the invention comprises a disc-form reflecting body 120 divided in two halves or circular elements 121, axially connectable one with the other approaching corresponding opposite profiles.

With reference to FIG. 2, each circular element 121 presents a perimeter groove 122 wherein a flexible laminar strip 130, with the LED 110 installed thereon, is insertable.

As illustrated in FIG. 3, for each LED 110 there are on the lamina 130 two welding bump contact 132 and a multi-holed bump contact 131 with metallised holes connecting such a bump contact with a similar back bump contact, for the heat transmission from the basis of the LED 110 backwards so as to allow the heat dissipation by conventional systems as a aluminium band 140 coupled with the lamina 130.

Making reference to FIG. 4, an electronic central unit 103, by the electrical cables 102 and the electrical source 104, allows the management and functional control of the lighting device 100 constituted by the body 120 divided in two halves and by the LED lamina 130 coupled to the dissipative band 140, preferably an aluminium band.

In fact, the LED can be positioned also without the laminar strip, which however turns out to be particularly advantageous.

According to a different, preferred embodiment, the reflecting body 120 is not formed by two semi-parabolic elements, but by an only parabolic reflector element. The lamina 130 will be positioned by connecting it from behind or in another known way.

Coming now to describe in more detail the light features of the device 100, one will note in FIG. 2 that only a part 123 of the circular element 121 needs to be reflecting with respect to the light of the LEDs 110. It is the part radially more external of the device and has a parabolic vertical cross-section (i.e. a cross-section with respect to a plane passing through the axis of the device), the LEDs 110 being positioned the most possible closed to the focus of the parabola.

In such a way, one obtains that the light beams emitted by each LED sum up to provide an exit circular beam that is uniform and horizontally directed.

In the case where the reflector element is not circular, but has its principal extension direction along a circle arc, or the principal extension direction is not a closed line, the LEDs are placed in a more dense way in the proximity of the ends (in the sense of the principal extension direction) of the reflector body, in such a way to compensate for the lacking of light rays coming from the other LEDs on that side further to the end.

In a further different embodiment, making now reference to FIG. 5, the reflector body 120 is not hollow any longer as in the previous embodiment, but is solid, in an optical material as for example glass or polycarbonated.

The parabolic surface 125 of such a reflector body can have a surface finish suited to reflect the light rays that impinge on it. The light rays that impinge with an angle larger than the critical angle are in fact reflected in any case.

Making now reference to figure from 6 to 8, a further embodiment is illustrated in the following, which is particularly practical and of easy construction.

The lighting device 100′ is constituted by a section bar 121,126,127 that comprises two parabolic branches 121′. In the focus of the parabola are placed, as in the other embodiments, the LEDs 110. The ends 127 are fixed to the dissipating element 140 and are so shaped that one can insert removable contrast elements 160, preferably of rubber. In such a way, one can insert between the section bar 121,126,127 and the dissipating element 140 the laminar strip 130 (that carries the LEDs 110) and fix it by simple insertion of the removable contrast elements 160.

Of course, the section bar 121,126,127 can be integrally formed with the dissipating element 140, as shown in the cross-section of FIG. 8.

In such a way, the construction of the device according to the invention becomes very simple, especially for rectilinear lighting devices.

In a way common to all the embodiments, it is possible to provide each LED with a lens 150 placed frontally at a certain distance. The distance is determined in such a way that all the rays that do not pass through the same lens will impinge on the internal surface 125 of the reflector body. In such a way, one avoids that some rays go behind the reflecting body 120, be it solid or hollow, and dissipate themselves in the environment, going therefore outside the beam collimated by the reflector body.

The present invention, because of the foregoing, allows to simplify and optimise in an innovative way the construction of a supplementary flashing signaling device with LED light by controlling a reduced amount of components, thus innovating the system of light emission, innovating the system of allocation and dissipation of the heat from the utilised LEDs, and cutting the production costs.

The device according to the invention has been further thought for the use alone or in combination with one or more identical devices to realise different geometrical forms of supplementary light signaling bar for emergency and rescue vehicles, considering aesthetical and technical grounds. In particular, more devices of the described type can be coupled one on the other in order to increase the light intensity.

As above briefly mentioned, the state of the art relevant to the lighting science and light signaling is characterised by single light emitters with a parabolic body that conveys, inside a certain solid angle, the light flux in order to increase the intensity.

The invention considers instead a parabolic vertical section which develops along a direction that can be rectilinear or curvilinear, in particular circular, thus determining in the latter case an ideal 360° reflector of the light rays emitted by LEDs placed in the focuses of such a circular sector with parabolic vertical cross-section.

Another innovative element is represented by the laminar strip whereon the LED are mounted, above all for all that concerns its flexibility and the LEDs installation way. Indeed such a strip is of reduced thickness and is very flexible so as to allow the positioning both on curved geometries and rectilinear geometries. To such lamina one couples a dissipation band.

The device according to the invention is for all this easily producible because it needs not much manpower, contrary to the prior art devices. The reflecting parabolic element is indeed unique for all the LEDs and these are pre-mounted on a unique support (laminar strip).

In particular, with LED of power larger that a Watt one obtains a light beam intensity adapted to the applications for light signaling of prioritary vehicles.

The preferred embodiments have been above described and some modifications of this invention have been suggested, but it should be understood that those skilled in the art can make variations and changes, without so departing from the related scope of protection, as defined by the following claims.

1. Lighting device (100,100′), wherein the light source comprises a plurality of LEDs (110) and a reflecting body (120) for the housing of the source and the conveying of the light according to a predefined exit angle of the light beam, characterised in that:
the internal surface (125) of said reflecting body (120) has a cross-section, with respect to its principal extension direction, that comprises at least two portions (121,121′) of a parabola which are symmetrical with respect to the axis of the same parabola;
substantially in the focus of said cross-section is housed a plurality of LED (110);
the LEDs (110) of said plurality of LEDs being connected to a first side of a laminar strip (130), on the second side (132) of the laminar strip, side facing in the direction opposite to said reflecting body, being connected a dissipative band (140) for dissipating heat generated by the LED (110).

2. Device according to claim 1, characterised in that said reflecting body (120) is a solid body, optically transparent in the directions of conveying of the light beam.

3. Device according to claim 2, characterised in that said reflecting body (120) is in polycarbonate.

4. Device according to claim 2 or 3, characterised in that said solid body is treated on its parabolic cross-section surface (125) so as to impede or minimise the exit of light rays from that surface.

5. Device according to claim 4, characterised in that the internal parabolic cross-section surface (125) is polished.

6. Device according to claim 4, characterised in that the internal parabolic cross-section surface (125) is rendered wholly reflecting towards the inside of the parabola.

7. Device according to any claims 1 to 6, characterised in that said reflecting body (120) is a hollow body.

8. Device according to claim 7, characterised in that:
the reflecting body (120) comprises two partially reflecting elements (121) with a principal extension direction, substantially identical and connectable with opposite corresponding profiles,
each partially reflecting element (121) comprises a groove (122) along said direction of principal extension, which is suited to receive said laminar strip (130),
the reflecting portion (123) of each partially reflecting element (121) presents a cross section, with respect to said principal extension direction, which is semi-parabolic, so as to form the reflecting portion of the cross-sectional reflecting body (120), the LEDs (110) being placed substantially in the focus of said parabolic cross-section.

9. Device according to any claims 1 to 8, characterised in that said reflecting body (120) is rectilinear, i.e. the principal extension direction is a straight line.

10. Device according to any claims 1 to 8, characterised in that the principal extension direction of said reflecting body (120) is curvilinear, i.e. the principal extension direction is a curve, possibly with rectilinear stretches.

11. Device according to claim 10, characterised in that the principal extension direction of said reflecting body (120) is partially circular.

12. Device according to claim 11, characterised in that said reflecting body (120) is circular.

13. Device according to any claims 10 to 12, characterised in that said laminar strip (130) is flexible.

14. Device according to any claims 1 to 13, characterised in that said dissipative band (140) is in aluminium.

15. Device according to any claims 1 to 14, characterised in that the LEDs of said plurality of LEDs (110) are connected so as to be equally spaced on the laminar strip.

16. Device according to any claims 1 to 14, characterised in that, when the reflecting body (120) is not closed, i.e. there are two end surfaces at the ends of the principal extension direction, the LEDs (110) are connected so as to be unequally spaced in the proximity of said end surfaces, so as to have a higher concentration of LEDs close to said end surfaces.

17. Device according to any claims 1 to 16, characterised in that said strip is a printed circuit.

18. Device according to claim 17, characterised in that said laminar strip (130) shows, for each LED, two metallic pads for welding the LED.

19. Device according to claim 17 or 18, characterised in that said laminar strip (130) is a bimetallic printed circuit and presents for each LED a metallic pad (131) with metallised holes for connection to a corresponding pad on the opposite side, that is directly contacting said heat dissipation band (140).

20. Device according to any claims 1 to 19, characterised in that the LEDs are lambertian LEDs.

21. Device according to any claims 1 to 20, characterised in that before each LED (110), at a pre-determined distance from it, a lens is placed, in such a way that the light rays pass only or across through said lens or go impinge on the parabolic surface of said reflecting body (120), so as to convey all rays that come from the LED, without loss.

22. Device according to any claims 1 to 21, characterised in that said dissipative band (130) is integrally formed with said reflecting body (120).

23. Device according to any claims 1 to 22, characterised in that said reflecting body (126,127,121′), in the connection with said dissipative band (140) as extension (127) of the two parabola branch, is shaped so as to be suited to receive two respective removable contrast elements (160) fixing said laminar strip (130).

24. Device according to claim 23, characterised in that said removable contrast elements (160) are rubber cylindrical packing.

25. Device according to any claims 1 to 24, characterised in that the ends (126) of said two parabola portions (121,121′) opposed to the LEDs (110) are shaped so as to constitute guide and partial seat of a transparent element (110) for LED protection.

26. Device according to any claims 1 to 25, characterised in that it comprises a supplementary dissipative device in the case where the LEDs (110) are red or yellow.
